(19) United States
(12) Patent Application Publication
(10) Pub. No.: US 2011/0090718 A1
(43) Pub. Date: Apr. 21, 2011

(54) SWITCHING POWER SUPPLY DEVICE

(75) Inventor: Naohiko MOROTA, Hyogo (JP)

(73) Assignee: PANASONIC CORPORATION, Osaka (JP)

(21) Appl. No.: 12/906,281

(22) Filed: Oct. 18, 2010

(30) Foreign Application Priority Data
Oct. 21, 2009 (JP) 2009-242798

(51) Int. Cl. H02M 3/335

(52) U.S. Cl. 363/21.12

(57) ABSTRACT

The present invention has as an object to introduce a switching power supply device having a simple circuit structure and controlling a secondary-side output voltage in a highly-accurate and stable manner. The switching power supply device includes: an auxiliary winding resetting detecting circuit which is connected to the auxiliary winding, monitors an auxiliary winding voltage pulse signal generated on the auxiliary winding, and generates an auxiliary winding reset signal indicating timing of which a secondary-side current finishes flowing into the secondary winding and the auxiliary winding voltage signal drops; and an auxiliary winding voltage sample hold circuit which holds the auxiliary winding voltage signal. The auxiliary winding voltage sample hold circuit includes a delaying circuit which delays the auxiliary winding voltage signal, and holds the auxiliary winding voltage pulse signal delayed by the delaying circuit with the timing indicated by the auxiliary winding reset signal.

### BACKGROUND OF THE INVENTION

(1) Field of the Invention

The present invention relates to switching power supply devices which detect and control a secondary-side output voltage at a primary side of a transformer for power conversion.

(2) Description of the Related Art

Typical switching power supply devices, employing a conventional transformer for power conversion, (i) detect a secondary-side output voltage using a control integrated circuit (IC) placed at the secondary side, and (ii) provide the primary side feedback of the secondary-side output voltage using a photocoupler.

However, such a secondary-side control IC and a photocoupler are expensive, leading to a cause of an increase in a manufacturing cost of the switching power supply device. The secondary-side control IC and the photocoupler are also obstacles to downsizing of the switching power supply device.

Thus, there are proposed techniques to eliminate the need for the secondary-side control IC and the photocoupler and to detect and control the secondary-side output voltage at the primary side of the transformer for power conversion. One of such techniques involves the following operations: after a switching element (a primary-side switching element) placed at the primary side of the transformer for power conversion turns off, the secondary-side output voltage is detected by sampling of an auxiliary winding voltage pulse signal which is proportional to a secondary-side output voltage appearing on an auxiliary winding of a transformer for power conversion. Then, according to the detected secondary-side output voltage, the technique executes controlling on and off operations of the switching element (See Patent Reference 1: U.S. Pat. No. 5,438,499 and Patent Reference 2: U.S. Pat. No. 7,349,229).

In a switching power supply device of Patent Reference 1, a primary-side switching element turns off. Then, after a predetermined time period, an auxiliary winding voltage pulse signal (auxiliary winding voltage signal) is sampled. Thanks to the above operation, ignored can be an effect of a spike voltage in the auxiliary winding voltage pulse signal appearing immediately after the primary-side switching element turns off.

### SUMMARY OF THE INVENTION

FIG. 5 is a timing chart showing an operation of a switching power supply device disclosed in Patent Reference 1.

A technique in Patent Reference 1 involves sampling an auxiliary winding voltage pulse signal Vbias at predetermined timing. This means that the auxiliary winding voltage pulse signal Vbias is sampled during a period (i) observed after a current Idp of a primary-side switching element goes down, and (ii) in which a secondary-side current Isec of a transformer for power conversion is flowing into a rectification diode provided on the secondary-side.

While the secondary-side current Isec of the transformer for power conversion is flowing into the rectification diode, the auxiliary winding voltage pulse signal Vbias is expressed in the following Equation (1), where Vo is a secondary-side output voltage, and Rd is a forward resistance component of the rectification diode:

Vbias=Vo+Rd×Isec (1)

According to the technique in Patent Reference 1, a sampled auxiliary winding voltage Vsample is not exactly proportional to the secondary-side output voltage Vo. Instead, Vsample depends on the forward resistance component Rd of the rectification diode and the secondary-side current Isec.

The forward resistance component Rd of the rectification diode varies depending on temperature characteristics and product to product. Such variations result in greater variations in the secondary-side output voltage Vo. In addition, when a current peak of the primary-side switching element changes as observed in the Pulse Width Modulation (PWM) control technique, the secondary-side current Isec changes depending on a load. Due to the above reasons, unfortunately, the technique in Patent Reference 1 cannot provide highly-accurate control on the secondary-side output voltage.

In order to solve the problem of Patent Reference 1, proposed in Patent Reference 2 is a technique to sample the auxiliary winding voltage pulse signal Vbias at a point, in Equation 1, where the secondary-side current Isec is almost zero, in other words, a contribution of the forward resistance component Rd of the rectification diode can be ignored.

FIG. 6 is a timing chart showing an operation of a switching power supply device disclosed in Patent Reference 2.

In the switching power supply device of the Patent Reference 2, first, a primary-side switching element turns off. Then, the switching power supply device detects (i) a generation of the secondary-side current Isec, and (ii) a drop in the auxiliary winding voltage pulse signal Vbias proportional to the secondary-side output voltage Vo appearing on an auxiliary winding of a transformer for power conversion. Based on the detections, the switching power supply device obtains a time period in which the secondary-side current Isec is flowing (a secondary-side on time period T2on). Then, in the next period, the switching power supply device measures a time period after the primary-side switching element turns off. When the measured time period equals to the secondary-side on time period T2on obtained in the previous period, the switching power supply device samples the auxiliary winding voltage pulse signal Vbias.

As described above, separately performing two control processes; namely time detection and voltage sampling, in a different period makes possible sampling a voltage occurring near an edge of the auxiliary winding voltage pulse signal Vbias. In other words, ignored can be an effect of the rectification diode represented in the second term of Equation (1), and thus the switching power supply device of the Patent Reference 2 can provide highly-accurate control on the secondary-side output voltage.

The technique introduced in Patent Reference 2, however, suffers the following: the secondary-side on time period T2on obtained out of a waveform of a period before needs to be temporarily held; at least two time period measuring circuits are required since the secondary-side on time period T2on needs to be measured in the next period; and a circuit to hold the measured time period is required. As a result, the technique faces such problems that the circuits will be complex and large, followed by an increasing cost.

In addition, great and small auxiliary winding voltage pulse signals could be mixed in the case where (i) a sudden change is observed in a load, and (ii) the transformer for power conversion is not properly designed. As a result, the technique introduced in Patent Reference 2 suffers the problems in that the auxiliary winding voltage pulse signals cannot be sampled at correct timing, resulting in unstable control of the switching power supply device.

The present invention is conceived in view of the above problems and has as an object to introduce a switching power supply device having a simple circuit structure and controlling a secondary-side output voltage in a highly-accurate and stable manner.

In order to achieve the above object, a switching power supply device according to an aspect of the present invention includes: a transformer for power conversion which includes a primary winding, a secondary winding, and an auxiliary winding; a switching element which (i) includes an input terminal, an output terminal, and a control terminal, and (ii) switches a first direct current (DC) voltage supplied to the primary winding, the input terminal being connected to the primary winding; an output voltage generating circuit which is connected to the secondary winding and generates a second DC voltage out of a voltage generated on the secondary winding through the switching of the switching element; an auxiliary winding resetting detecting circuit which (i) is connected to the auxiliary winding, (ii) monitors an auxiliary winding voltage signal generated on the auxiliary winding, and (iii) generates an auxiliary winding reset signal indicating timing of which a secondary-side current finishes flowing into the secondary winding and the auxiliary winding voltage signal drops; an auxiliary winding voltage sample hold circuit which (i) is connected to the auxiliary winding resetting detecting circuit and to the auxiliary winding, and (ii) holds the auxiliary winding voltage signal; and a control circuit which (i) is connected to the auxiliary winding voltage sample hold circuit, (ii) generates a control signal controlling the switching element to turn on and off depending on the auxiliary winding voltage signal held by the auxiliary winding voltage sample hold circuit, and (iii) provides the control signal to the control terminal of the switching element, wherein the auxiliary winding voltage sample hold circuit (i) includes a delaying circuit which delays the auxiliary winding voltage signal, and (ii) holds the auxiliary winding voltage signal delayed by the delaying circuit from reception of the auxiliary winding reset signal by the auxiliary winding voltage sample hold circuit receives to the turn off of the switching element.

According to the above structure, the auxiliary winding resetting detecting circuit detects a drop of the auxiliary winding voltage signal. At the detected timing, the auxiliary winding voltage signal is sampled. Here, the timing to detect the drop of the auxiliary winding voltage signal is behind timing of which the auxiliary winding voltage signal actually starts to drop. However, the auxiliary winding voltage, which is held by the auxiliary winding voltage sample hold circuit to control on and off operations of the switching element, is obtained out of the auxiliary winding voltage signal delayed by the delaying circuit. Thus, the timing to detect the drop is regarded as the timing of which the auxiliary winding voltage signal starts to drop. The conventional technique of Patent Reference 2 measures and holds the secondary-side on time period T2on because the conventional technique uses the auxiliary winding voltage signal to control the secondary-side output voltage. The switching power supply device according to the aspect of the present invention eliminates the need for such measuring and holding, which contributes to a less complex circuit for the switching power supply device. Compared with the conventional technique of the Patent Reference 2, in addition, the switching power supply device does not rely on the secondary-side current Isec when determining sampling timing of the auxiliary winding voltage signal. Hence, the switching power supply device can control the secondary-side output voltage using the most suitable auxiliary winding voltage even in the case where the secondary-side output voltage drastically changes due to a sudden change of load. Accordingly, the switching power supply device achieves stable control of the secondary-side output voltage. The resulting switching power supply device to be achieved is simple in a circuit structure and is capable of achieving highly accurate and stable control on the secondary-side output voltage.

In the switching power supply device according the aspect of the present invention may include, the auxiliary winding resetting detecting circuit may include a differentiating circuit and a comparator, the differentiating circuit generating a signal indicating a change in the auxiliary winding voltage signal, and the comparator comparing the signal with a reference voltage to generate the auxiliary winding reset signal.

As described above, the present invention eliminates the need for measuring and holding the secondary-side on time period

T2on within the same period. Accordingly, the resulting switching power supply device is simple and small in a circuit structure, which contributes to a reduction in a chip cost. Furthermore, the switching power supply device requires no expensive parts, such as an integrated circuit (IC) for detecting a secondary-side output voltage and a photocoupler. This achieves a less-expensive and smaller switching power supply device. In addition, the switching power supply device can detect the auxiliary winding voltage signal at the most suitable point of the auxiliary winding voltage signal even in the case where the secondary-side output voltage drastically changes due to a sudden change of load. Accordingly, the secondary-side output voltage can be stably controlled. Moreover, the switching power supply device uses the auxiliary winding voltage signal to control the secondary-side output voltage. This makes possible controlling the secondary-side output voltage with high accuracy.

### FURTHER INFORMATION ABOUT TECHNICAL BACKGROUND TO THIS APPLICATION

The disclosure of Japanese Patent Application No. 2009-242798 filed on Oct. 21, 2009 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a circuit diagram showing a structure of a switching power supply device according to Embodiment 1 in the present invention;

FIG. 2 is a timing chart showing an operation of each unit included in the switching power supply device according to Embodiment 1 in the present invention;

FIG. 3 is a circuit diagram showing a structure of a switching power supply device according to Embodiment 2 in the present invention;

FIG. 4 is a circuit diagram showing a structure of a switching power supply device according to Embodiment 3 in the present invention;

FIG. 5 is a timing chart showing an operation of a conventional switching power supply device;

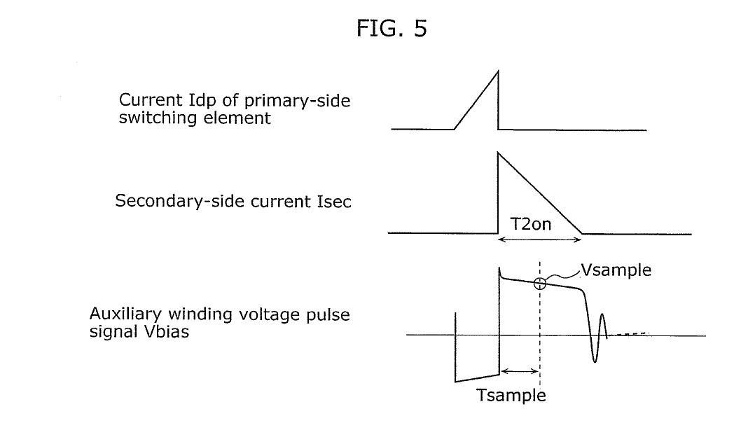

FIG. 6 is a timing chart showing an operation of another conventional switching power supply device;

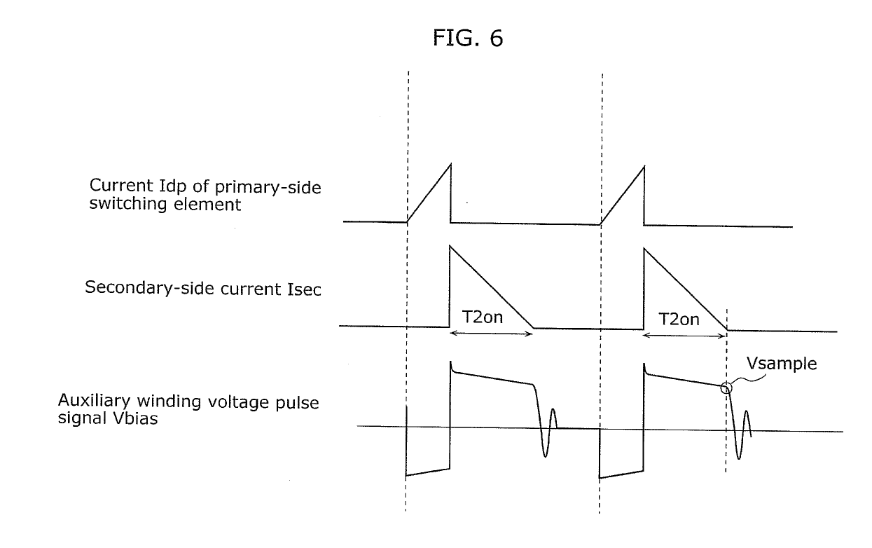

FIG. 7 is a circuit diagram showing a structure of a switching power supply device according to Embodiment 4 in the present invention; and

FIG. 8 is a timing chart showing an operation of the switching power supply device according to Embodiment 4 in the present invention.

### DESCRIPTION OF THE PREFERRED EMBODIMENTS

Described hereinafter in detail are switching power supply devices according to Embodiments in the present invention, with reference to the drawings.

### Embodiment 1

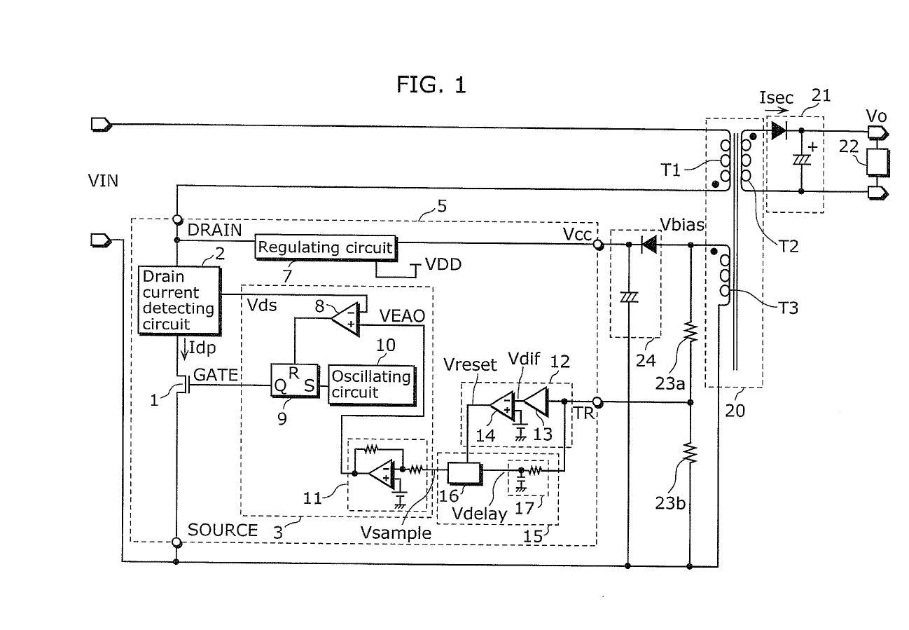

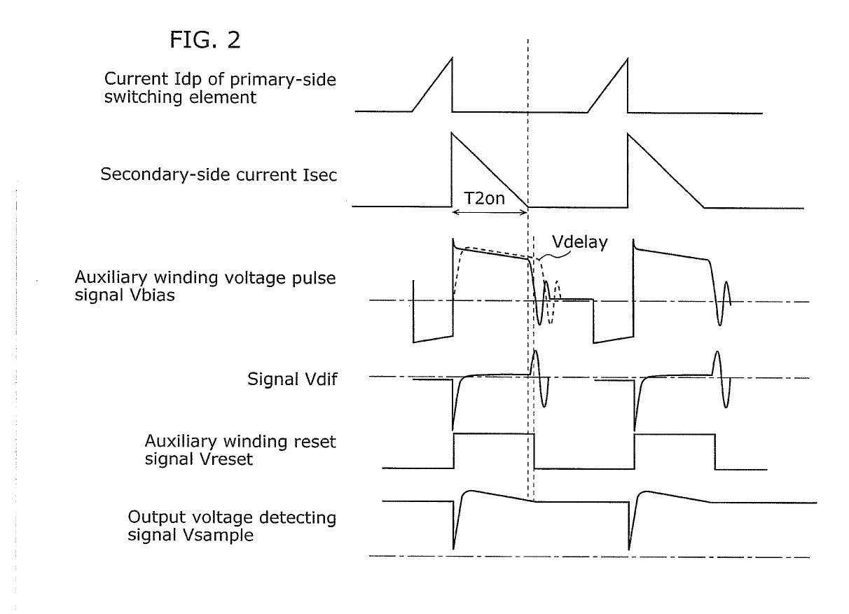

FIG. 1 is a circuit diagram showing a structure of a switching power supply device according to Embodiment 1 in the present invention. FIG. 2 is a timing chart showing an operation of the switching power supply device.

The switching power supply device includes the following: a control circuit for driving switching element 5, a transformer for power conversion 20, an output voltage generating circuit 21, resistors 23a and 23b, and a rectification smoothing circuit 24.

The control circuit for driving switching element 5 includes the following: a switching element 1 having a power MOSFET, a drain current detecting circuit 2, a control circuit 3, a regulating circuit 7, an auxiliary winding resetting detecting circuit 12, and an auxiliary winding voltage sample hold circuit 15. The control circuit for driving switching element 5 includes semiconductor devices (semiconductor devices for a switching power supply) formed on a single semiconductor substrate, and has four terminals as external connecting terminals; namely, a DRAIN terminal, a VCC terminal, a TR terminal, and a SOURCE terminal.

The transformer for power conversion 20 includes a primary winding T1, a secondary winding T2, and an auxiliary winding T3. One terminal on the primary winding T1 included in the transformer for power conversion 20 is connected to a positive terminal provided at an input side (primary side) of the switching power supply device. The other terminal is connected to a negative terminal provided at the input side (primary side) of the switching power supply device via the switching element 1 working as a high voltage semiconductor element.

The switching element 1 has an input terminal, an output terminal, and a control terminal. The input terminal is connected to the primary winding T1. The output terminal is connected to the negative terminal provided at the input side of the switching power supply device. The switching element 1 responds to a control signal applied to the control terminal to switch (oscillate) between electrically connecting (turn-on) and disconnecting (turn-off) the input terminal and the output terminal. Thus, the switching element 1 switches a direct current (DC) voltage to be supplied to the primary winding T1.

The output voltage generating circuit 21 is connected to the secondary winding T2 included in the transformer for power conversion 20. Through the on-and-off operation (switching operation) of the switching element 1, the output voltage generating circuit 21 generates a DC voltage out of a voltage generated on the secondary-winding T2. Hence, the energy generated on the secondary-winding T2 included in the transformer for power conversion 20 is supplied to a load 22 as a stabilized DC voltage Vo.

The auxiliary winding T3 included in the transformer for power conversion 20 is connected to the rectification smoothing circuit 24 in order to supply a high-voltage input power source to the VCC terminal of the control circuit for driving switching element 5.

In the control circuit for driving switching element 5, (i) the switching element 1 is connected between the DRAIN terminal and the SOURCE terminal, and (ii) the drain current detecting circuit 2 observes an element current flowing into the switching element 1, and provides an element current detecting signal Vds to the control circuit 3.

The regulating circuit 7 is connected to the VCC terminal and the DRAIN terminal. The regulating circuit 7 supplies a current from one of the DRAIN terminal and the VCC terminal to a power supply for internal circuit VDD in order to stabilize a voltage of the power supply for internal circuit VDD at a constant value.

It is noted that, in FIG. 1, the VCC terminal is connected to the auxiliary winding T3 via the rectification smoothing circuit 24 in order to save power consumption of the control circuit for driving switching element 5. Instead, the VCC terminal may be disconnected from the rectification smoothing circuit 24 and auxiliary winding T3 so that only the power supply for internal circuit VDD can be supplied from the DRAIN terminal.

The auxiliary winding resetting detecting circuit 12 and the auxiliary winding voltage sample hold circuit 15 are connected to the TR terminal.

The auxiliary winding resetting detecting circuit 12 is connected to the auxiliary winding T3 in order to monitor an auxiliary winding voltage pulse signal Vbias generated on the auxiliary winding T3. When a secondary-side current Isec flowing into the secondary winding T2 finishes flowing, and the auxiliary winding voltage pulse signal Vbias drops, the auxiliary winding resetting detecting circuit 12 generates an auxiliary winding reset signal Vreset. Here, the signal Vreset indicates timing of which the signal Vbias drops.

The auxiliary winding resetting detecting circuit 12 includes a differentiating circuit 13 and a comparator 14. The differentiating circuit 13 generates a signal Vdif indicating a voltage change in the auxiliary winding voltage pulse signal Vbias. Specifically, the differentiating circuit 13 generates the signal Vdif by differentially transforming a resistor dividing signal of the auxiliary winding voltage pulse signal Vbias provided to the TR terminal. The comparator 14 compares the signal Vdif with a reference voltage to generate the auxiliary winding reset signal Vreset.

Hence, the auxiliary winding resetting detecting circuit 12 is capable of detecting a changing point of the auxiliary winding voltage pulse signal Vbias. Here, the changing point of the auxiliary winding voltage pulse signal Vbias is almost equal to timing (hereinafter referred to as an auxiliary winding resetting point) at which the switching element 1 turns off, the secondary-side current Isec flows into the secondary winding T2 of the transformer for power conversion 20, and the secondary-side current Isec disappears. The auxiliary winding voltage sample hold circuit 15 is connected to the auxiliary winding resetting detecting circuit 12 and the auxiliary winding T3. The auxiliary winding voltage sample hold circuit 15 also includes a delaying circuit 17 to hold (sample) an auxiliary winding voltage pulse signal Vdelay. Here, the signal Vdelay is delayed by the delaying circuit 17 at the timing that the auxiliary winding reset signal Vreset indicates.

Specifically, the auxiliary winding voltage sample hold circuit 15 includes the delaying circuit 17 and a sample hold circuit 16. The delaying circuit 17 is connected to the TR terminal. The sample hold circuit 16 receives the auxiliary winding reset signal Vreset.

The delaying circuit 17 is structured, for example, in a low-pass filter employing a capacitor and a resistor. The delaying circuit 17 delays the auxiliary winding voltage pulse signal Vbias found on the TR terminal, and provides the delayed auxiliary winding voltage pulse signal Vdelay.

The sample hold circuit 16 holds the signal Vdelay provided from the delaying circuit 17 at least until the switching element 1 turns off in the next period so as to generate an output voltage detecting signal Vsample. Here the signal Vdelay is provided from delaying circuit 17 when the sample hold circuit 16 receives the auxiliary winding reset signal Vreset. Specifically, in order to generate the output voltage detecting signal Vsample, the sample hold circuit 16 holds the auxiliary winding voltage pulse signal Vdelay delayed by the delaying circuit from the reception of the auxiliary winding reset signal Vreset by the sample hold circuit 16 to the turn off of the switching element 1.

To stabilize the control, a low-pass filter (not shown) may be connected to the output of the sample hold circuit 16.

In FIG. 1, the auxiliary winding resetting detecting circuit 12 includes the differentiating circuit 13; instead, the auxiliary winding resetting detecting circuit 12 may omit the differentiating circuit 13, and include only the comparator 14 as far as the delaying circuit 17 has a long enough delay time period to be set.

Preferably, the delay time period of the delaying circuit 17 is set longer than a delay time period appearing between the auxiliary winding resetting point (timing of which the secondary-side current flowing into the secondary winding T2 finishes flowing) and provision (generation) of the auxiliary winding reset signal Vreset by the auxiliary winding resetting detecting circuit 12 (to a change of a level of the auxiliary winding reset signal Vreset).

The control circuit 3 is connected to the auxiliary winding voltage sample hold circuit 15. Depending on an output of the auxiliary winding voltage pulse signal Vdelay held by the auxiliary winding voltage sample hold circuit 15, the control circuit 3 generates the control signal controlling the switching element 1 to turn on and off, and provides the generated control signal to the control terminal of the switching element 1.

Specifically, the control circuit 3 includes an oscillating circuit 10, a feedback control circuit 11, a drain current control circuit 8, and an RS latch circuit 9.

Connected to the auxiliary winding voltage sample hold circuit 15, the feedback control circuit 11 compares the output voltage detecting signal Vsample with the reference voltage and amplifies an error so as to generate a drain current control signal VEAO.

The oscillating circuit 10 generates a clock signal working as a turn-on control pulse of the switching element 1, and provides the clock signal to the set input of the RS latch circuit 9.

The drain current control circuit 8 compares the element current detecting signal Vds of the drain current detecting circuit 2 with the drain current control signal VEAO. Once the element current detecting signal Vds becomes greater than the drain current control signal VEAO, the drain current control circuit 8 provides a reset pulse to the reset input of the RS latch circuit 9.

The RS latch circuit 9 is connected to the control terminal of the switching element 1. The RS latch circuit 9 generates (i) a high-level output signal in response to the clock signal of the oscillating circuit 10, and (ii) a low-level output signal in response to the reset pulse of the drain current control circuit 8. Then, the RS latch circuit 9 provides the generated output signals to the control terminal as the control signals.

As described above, the switching power supply device according to Embodiment 1 in the present invention employs the PWM current mode control technique. Specifically, the switching power supply device controls (i) a turn-on of the switching element 1 using a fixed frequency clock signal provided from the oscillating circuit 10, and (ii) a peak of an element current flowing into the switching element 1 using the drain current control signal VEAO generated out of the auxiliary winding voltage pulse signal Vbias.

It is noted that FIG. 1 exemplifies a switching power supply device employing the PWM current mode control technique. Concurrently, the control technique of the control circuit 3 shall not be limited to the PWM current mode control technique as far as the auxiliary winding resetting detecting circuit 12 and the auxiliary winding voltage sample hold circuit 15 generate the output voltage detecting signal Vsample out of the auxiliary winding voltage pulse signal Vbias. For example, Embodiment 1 can be applied to the following: the PWM voltage mode control technique controlling on-duty of the switching element 1 in response to the output voltage detecting signal Vsample; the Pulse Frequency Modulation (PFM) control technique controlling on-timing, a frequency, and an off time period of the switching element 1 in response to the output voltage detecting signal Vsample; and the quasi-resonant technique.

As described above, the switching power supply device according to Embodiment 1 causes the auxiliary winding resetting detecting circuit 12 to detect a drop of the auxiliary winding voltage pulse signal Vbias (a drop of an output voltage appearing after the switching element 1 turns off). At timing when the drop is detected, the auxiliary winding voltage pulse signal Vbias is sampled. Here, the timing to detect the drop of the auxiliary winding voltage pulse signal Vbias is behind timing of which the auxiliary winding voltage pulse signal Vbias starts to drop. However, the auxiliary winding voltage, which is held by the auxiliary winding voltage sample hold circuit 15 to control on and off operation of the switching element 1, is obtained out of the auxiliary winding voltage pulse signal Vbias delayed by the delaying circuit 17. Thus, the timing to detect the drop is regarded as the timing of which the auxiliary winding voltage pulse signal Vbias starts to drop. The conventional technique of Patent Reference 2 measures and holds the secondary-side on time period T2on because the conventional technique uses the auxiliary winding voltage pulse signal to control the secondary-side output voltage. The switching power supply device according to Embodiment 1 eliminates the need for such measuring and holding, which contributes to a less complex circuit for the switching power supply device. Compared with the conventional technique of the Patent Reference 2, in addition, the switching power supply device according to Embodiment 1 does not rely on the secondary-side current Isec when determining sampling timing of the auxiliary winding voltage pulse signal. Hence, the switching power supply device can control the secondary-side output voltage using the most suitable auxiliary winding voltage even in the case where the secondary-side output voltage drastically changes due to a sudden change of load. Accordingly, the secondary-side output voltage can be stably controlled. The resulting switching power supply device is simple in a circuit structure and is capable of achieving highly accurate and stable control on the secondary-side output voltage.

### Embodiment 2

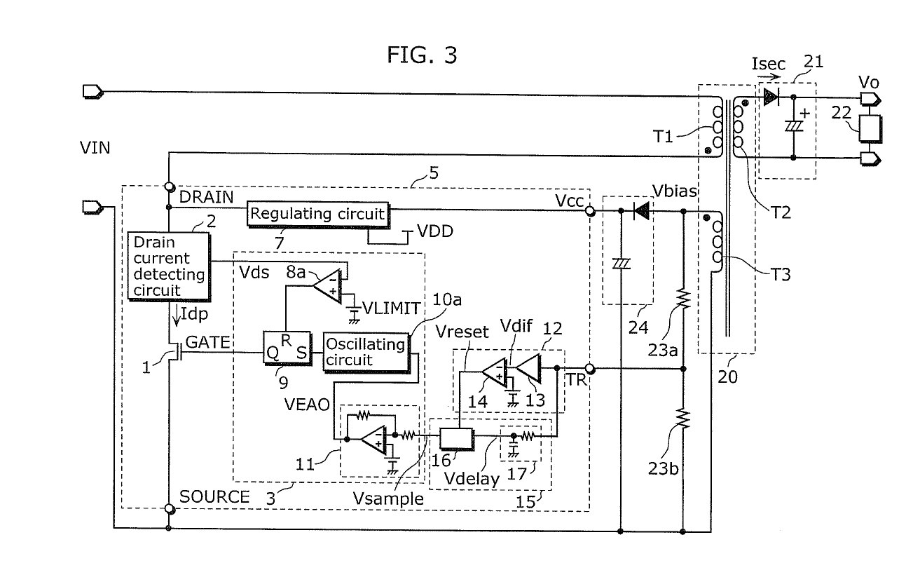

FIG. 3 is a circuit diagram showing a structure of a switching power supply device according to Embodiment 2 in the present invention.

The switching power supply device according to Embodiment 1 in the present invention employs the PWM current mode control technique. The switching power supply device according to Embodiment 2 in the present invention differs from that according to Embodiment 1 in that an employed technique for the former is the Pulse Frequency Modulation (PMF) control technique.

The switching power supply device according to Embodiment 2 includes the following: the control circuit for driving switching element 5, the transformer for power conversion 20, the output voltage generating circuit 21, the resistors 23a and 23b, and the rectification smoothing circuit 24.

The control circuit for driving switching element 5 includes the following: the switching element 1 having a power MOSFET, the drain current detecting circuit 2, the control circuit 3, the regulating circuit 7, the auxiliary winding resetting detecting circuit 12, and the auxiliary winding voltage sample hold circuit 15. The control circuit for driving switching element 5 includes semiconductor devices (semiconductor devices for a switching power supply) formed on a single semiconductor substrate, and has four terminals as external connecting terminals; namely, the DRAIN terminal, the VCC terminal, the TR terminal, and the SOURCE terminal.

The transformer for power conversion 20 includes the primary winding T1, the secondary winding T2, and the auxiliary winding T3. One terminal on the primary winding T1 included in the transformer for power conversion 20 is connected to a positive terminal provided at an input side (primary side) of the switching power supply device. The other terminal is connected to a negative terminal provided at the input side (primary side) of the switching power supply device via the switching element 1 working as a high voltage semiconductor element.

The switching element 1 has an input terminal, an output terminal, and a control terminal. The input terminal is connected to the primary winding T1. The output terminal is connected to the negative terminal provided at the input side of the switching power supply device. The switching element 1 responds to a control signal applied to the control terminal to switch (oscillate) between electrically connecting (turn-on) and disconnecting (turn-off) the input terminal and the output terminal. Thus, the switching element 1 switches a DC voltage to be supplied to the primary winding T1.

The output voltage generating circuit 21 is connected to the secondary winding T2 included in the transformer for power conversion 20. Through the on-and-off operation (switching operation) of the switching element 1, the output voltage generating circuit 21 generates a DC voltage out of a voltage generated on the secondary-winding T2. Hence, the energy generated on the secondary-winding T2 included in the transformer for power conversion 20 is supplied to the load 22 as a stabilized DC voltage Vo.

The auxiliary winding T3 included in the transformer for power conversion 20 is connected to the rectification smoothing circuit 24 in order to supply a high-voltage input power source to the VCC terminal of the control circuit for driving switching element 5.

In the control circuit for driving switching element 5, (i) the switching element 1 is connected between the DRAIN terminal and the SOURCE terminal, and (ii) the drain current detecting circuit 2 observes an element current flowing into the switching element 1, and provides an element current detecting signal Vds to the control circuit 3.

The regulating circuit 7 is connected to the VCC terminal and the DRAIN terminal. The regulating circuit 7 supplies a current from one of the DRAIN terminal and the VCC terminal to a power supply for internal circuit VDD in order to stabilize a voltage of the power supply for internal circuit VDD at a constant value.

It is noted that, in FIG. 3, the VCC terminal is connected to the auxiliary winding T3 via the rectification smoothing circuit 24 in order to save power consumption of the control circuit for driving switching element 5. Instead, the VCC terminal may be disconnected from the rectification smoothing circuit 24 and auxiliary winding T3 so that only the power supply for internal circuit VDD can be supplied from the DRAIN terminal.

The auxiliary winding resetting detecting circuit 12 and the auxiliary winding voltage sample hold circuit 15 are connected to the TR terminal.

The auxiliary winding resetting detecting circuit 12 is connected to the auxiliary winding T3 in order to monitor an auxiliary winding voltage pulse signal Vbias generated on the auxiliary winding T3. When the auxiliary winding voltage pulse signal Vbias drops once a secondary-side current Isec flowing into the secondary winding T2 finishes flowing, the auxiliary winding resetting detecting circuit 12 generates an auxiliary winding reset signal Vreset. Here, the signal Vreset indicates timing of which the signal Vbias drops.

The auxiliary winding resetting detecting circuit 12 includes a differentiating circuit 13 and a comparator 14. The differentiating circuit 13 generates a signal Vdif indicating a voltage change in the auxiliary winding voltage pulse signal Vbias. Specifically, the differentiating circuit 13 generates the signal Vdif whose resistor dividing signal of the auxiliary winding voltage pulse signal Vbias provided to the TR terminal is differentially transformed. The comparator 14 compares the signal Vdif with a reference voltage, and generates the auxiliary winding reset signal Vreset.

Hence, the auxiliary winding resetting detecting circuit 12 is capable of detecting a changing point of the auxiliary winding voltage pulse signal Vbias. Here, the changing point of the auxiliary winding voltage pulse signal Vbias is almost equal to timing (hereinafter referred to as an auxiliary winding resetting point) at which the switching element 1 turns off, the secondary-side current Isec flows into the secondary winding T2 of the transformer for power conversion 20, and the secondary-side current Isec disappears.

The auxiliary winding voltage sample hold circuit 15 is connected to the auxiliary winding resetting detecting circuit 12 and the auxiliary winding T3. The auxiliary winding voltage sample hold circuit 15 also includes a delaying circuit 17 to hold (sample) an auxiliary winding voltage pulse signal Vdelay. Here, the signal Vdelay is delayed by the delaying circuit 17 at the timing that the auxiliary winding reset signal Vreset indicates.

Specifically, the auxiliary winding voltage sample hold circuit 15 includes the delaying circuit 17 and a sample hold circuit 16. The delaying circuit 17 is connected to the TR terminal. The sample hold circuit 16 receives the auxiliary winding reset signal Vreset.

The delaying circuit 17 is structured, for example, in a low-pass filter employing a capacitor and a resistor. The delaying circuit 17 delays the auxiliary winding voltage pulse signal Vbias found on the TR terminal, and provides the delayed auxiliary winding voltage pulse signal Vdelay.

The sample hold circuit 16 holds the signal Vdelay provided from the delaying circuit 17 at least until the switching element 1 turns off in the next period so as to generate an output voltage detecting signal Vsample. Here the signal Vdelay is generated by delaying circuit 17 when the sample hold circuit 16 receives the auxiliary winding reset signal Vreset.

To stabilize the control, a low-pass filter (not shown) may be connected to the output of the sample hold circuit 16.

In FIG. 3, the auxiliary winding resetting detecting circuit 12 includes the differentiating circuit 13; instead, the auxiliary winding resetting detecting circuit 12 may omit the differentiating circuit 13, and include only the comparator 14 as far as the delaying circuit 17 has long enough delay time to be set.

Preferably, the delay time period of the delaying circuit 17 is set longer than a delay time period appearing between the auxiliary winding resetting point and provision of the auxiliary winding reset signal Vreset by the auxiliary winding resetting detecting circuit 12.

The control circuit 3 is connected to the auxiliary winding voltage sample hold circuit 15. Depending on an output of the auxiliary winding voltage pulse signal Vdelay held by the auxiliary winding voltage sample hold circuit 15, the control circuit 3 generates the control signal controlling the switching element 1 to turn on and off, and provides the generated control signal to the control terminal of the switching element 1.

Specifically, the control circuit 3 includes the oscillating circuit 10a, the feedback control circuit 11, a drain current control circuit 8a, and the RS latch circuit 9.

Connected to the auxiliary winding voltage sample hold circuit 15, the feedback control circuit 11 compares the output voltage detecting signal Vsample with the reference voltage and amplifies an error so as to generate a drain current control signal VEAO.

The oscillating circuit 10a generates a clock signal working as a turn-on control pulse of the switching element 1, and provides the clock signal to the set input of the RS latch circuit 9. The oscillating circuit 10a is connected to the feedback control circuit 11. Based on a change of the drain current control signal VEAO, an oscillatory frequency of the clock signal change.

The drain current control circuit 8a compares the element current detecting signal Vds of the drain current detecting circuit 2 with a drain current maximum voltage VLIMIT. Once the element current detecting signal Vds becomes greater than the drain current maximum voltage VLIMIT, the drain current control circuit 8a provides a reset pulse to the reset input of the RS latch circuit 9.

The RS latch circuit 9 is connected to the control terminal of the switching element 1. The RS latch circuit 9 generates (i) a high-level output signal in response to the clock signal of the oscillating circuit 10a, and (ii) a low-level output signal in response to the reset pulse of the drain current control circuit 8a. Then, the RS latch circuit 9 provides the generated output signals to the control terminal as the control signals.

As described above, the switching power supply device according to Embodiment 2 in the present invention employs the PFM control technique. Specifically, in the switching power supply device, a frequency of the clock signal provided from the oscillating circuit 10a controlling a turn-on of the switching element 1 changes according to a change of the drain current control signal VEAO generated out of the auxiliary winding voltage pulse signal Vbias, and a peak of an element current flowing into the switching element 1 is fixed by the drain current maximum voltage VLIMIT.

The resulting switching power supply device according to Embodiment 2 is simple in a circuit structure and is capable of achieving highly accurate and stable control on the secondary-side output voltage, so the switching power supply device according to Embodiment 1 is.

### Embodiment 3

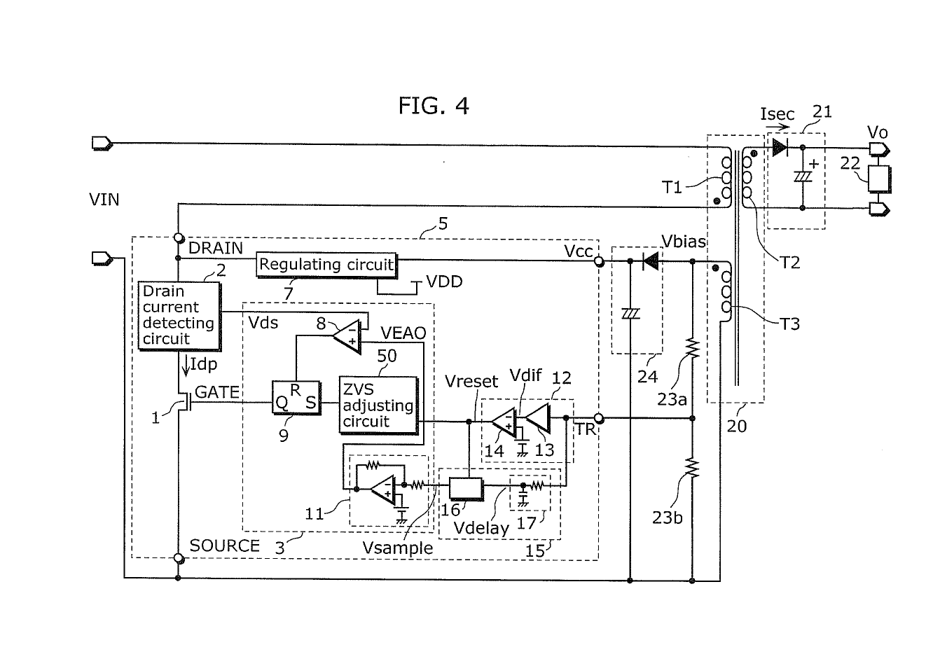

FIG. 4 is a circuit diagram showing a structure of a switching power supply device according to Embodiment 3 in the present invention.

The switching power supply device according to Embodiment 3 includes the following: the control circuit for driving switching element 5, the transformer for power conversion 20, the output voltage generating circuit 21, the resistors 23a and 23b, and the rectification smoothing circuit 24.

The control circuit for driving switching element 5 includes the following: the switching element 1 having a power MOSFET, the drain current detecting circuit 2, the control circuit 3, the regulating circuit 7, the auxiliary winding resetting detecting circuit 12, and the auxiliary winding voltage sample hold circuit 15. The control circuit for driving switching element 5 includes semiconductor devices (semiconductor devices for a switching power supply) formed on a single semiconductor substrate, and has four terminals as external connecting terminals; namely, the DRAIN terminal, the VCC terminal, the TR terminal, and the SOURCE terminal.

The transformer for power conversion 20 includes the primary winding T1, the secondary winding T2, and the auxiliary winding T3. One terminal on the primary winding T1 included in the transformer for power conversion 20 is connected to a positive terminal provided at an input side (primary side) of the switching power supply device. The other terminal is connected to a negative terminal provided at the input side (primary side) of the switching power supply device via the switching element 1 working as a high voltage semiconductor element.

The switching element 1 has an input terminal, an output terminal, and a control terminal. The input terminal is connected to the primary winding T1. The output terminal is connected to the negative terminal provided at the input side of the switching power supply device. The switching element 1 responds to a control signal applied to the control terminal to switch (oscillate) between electrically connecting (turn-on) and disconnecting (turn-off) the input terminal and the output terminal. Thus, the switching element 1 switches a DC voltage to be supplied to the primary winding T1.

The output voltage generating circuit 21 is connected to the secondary winding T2 included in the transformer for power conversion 20. Through the on-and-off operation (switching operation) of the switching element 1, the output voltage generating circuit 21 generates a DC voltage out of a voltage generated on the secondary-winding T2. Hence, the energy generated on the secondary-winding T2 included in the transformer for power conversion 20 is supplied to the load 22 as a stabilized DC voltage Vo.

The auxiliary winding T3 included in the transformer for power conversion 20 is connected to the rectification smoothing circuit 24 in order to supply a high-voltage input power source to the VCC terminal of the control circuit for driving switching element 5.

In the control circuit for driving switching element 5, (i) the switching element 1 is connected between the DRAIN terminal and the SOURCE terminal, and (ii) the drain current detecting circuit 2 observes an element current flowing into the switching element 1, and provides an element current detecting signal Vds to the control circuit 3.

The regulating circuit 7 is connected to the VCC terminal and the DRAIN terminal. The regulating circuit 7 supplies a current from one of the DRAIN terminal and the VCC terminal to a power supply for internal circuit VDD in order to stabilize a voltage of the power supply for internal circuit VDD at a constant value.

It is noted that, in FIG. 4, the VCC terminal is connected to the auxiliary winding T3 via the rectification smoothing circuit 24 in order to save power consumption of the control circuit for driving switching element 5. Instead, the VCC terminal may be disconnected from the rectification smoothing circuit 24 and auxiliary winding T3 so that only the power supply for internal circuit VDD can be supplied from the DRAIN terminal.

The auxiliary winding resetting detecting circuit 12 and the auxiliary winding voltage sample hold circuit 15 are connected to the TR terminal.

The auxiliary winding resetting detecting circuit 12 is connected to the auxiliary winding T3 in order to monitor an auxiliary winding voltage pulse signal Vbias generated on the auxiliary winding T3. When the auxiliary winding voltage pulse signal Vbias drops once a secondary-side current Isec flowing into the secondary winding T2 finishes flowing, the auxiliary winding resetting detecting circuit 12 generates an auxiliary winding reset signal Vreset. Here, the signal Vreset indicates timing of which the signal Vbias drops. The auxiliary winding resetting detecting circuit 12 includes the differentiating circuit 13 and the comparator 14. The differentiating circuit 13 generates a signal Vdif indicating a voltage change in the auxiliary winding voltage pulse signal Vbias. Specifically, the differentiating circuit 13 generates the signal Vdif whose resistor dividing signal of the auxiliary winding voltage pulse signal Vbias provided to the TR terminal is differentially transformed. The comparator 14 compares the signal Vdif with a reference voltage, and generates the auxiliary winding reset signal Vreset.

Hence, the auxiliary winding resetting detecting circuit 12 is capable of detecting a changing point of the auxiliary winding voltage pulse signal Vbias. Here, the changing point of the auxiliary winding voltage pulse signal Vbias is almost equal to timing (hereinafter referred to as an auxiliary winding resetting point) at which the switching element 1 turns off, the secondary-side current Isec flows into the secondary winding T2 of the transformer for power conversion 20, and the secondary-side current Isec disappears.

The auxiliary winding voltage sample hold circuit 15 is connected to the auxiliary winding resetting detecting circuit 12 and the auxiliary winding T3. The auxiliary winding voltage sample hold circuit 15 also includes a delaying circuit 17 to hold (sample) an auxiliary winding voltage pulse signal Vdelay. Here, the signal Vdelay is delayed by the delaying circuit 17 at the timing that the auxiliary winding reset signal Vreset indicates.

Specifically, the auxiliary winding voltage sample hold circuit 15 includes the delaying circuit 17 and a sample hold circuit 16. The delaying circuit 17 is connected to the TR terminal. The sample hold circuit 16 receives the auxiliary winding reset signal Vreset.

The delaying circuit 17 is structured, for example, in a low-pass filter employing a capacitor and a resistor. The delaying circuit 17 delays the auxiliary winding voltage pulse signal Vbias found on the TR terminal, and provides the delayed auxiliary winding voltage pulse signal Vdelay.

The sample hold circuit 16 holds the signal Vdelay provided from the delaying circuit 17 at least until the switching element 1 turns off in the next period so as to generate an output voltage detecting signal Vsample. Here the signal Vdelay is generated by delaying circuit 17 when the sample hold circuit 16 receives the auxiliary winding reset signal Vreset.

To stabilize the control, a low-pass filter (not shown) may be connected to the output of the sample hold circuit 16.

In FIG. 4, the auxiliary winding resetting detecting circuit 12 includes the differentiating circuit 13; instead, the auxiliary winding resetting detecting circuit 12 may omit the differentiating circuit 13, and include only the comparator 14 as far as the delaying circuit 17 has long enough delay time to be set.

Preferably, the delay time period of the delaying circuit 17 is set longer than a delay time period appearing between the auxiliary winding resetting point and provision of the auxiliary winding reset signal Vreset by the auxiliary winding resetting detecting circuit 12.

The control circuit 3 is connected to the auxiliary winding voltage sample hold circuit 15. Depending on an output of the auxiliary winding voltage pulse signal Vdelay held by the auxiliary winding voltage sample hold circuit 15, the control circuit 3 generates the control signal controlling the switching element 1 to turn on and off, and provides the generated control signal to the control terminal of the switching element 1.

Specifically, the control circuit 3 includes a ZVS adjusting circuit 50, the feedback control circuit 11, the drain current control circuit 8, and the RS latch circuit 9.

Connected to the auxiliary winding voltage sample hold circuit 15, the feedback control circuit 11 compares the output voltage detecting signal Vsample with the reference voltage and amplifies an error so as to generate a drain current control signal VEAO.

The ZVS adjusting circuit 50 receives the auxiliary winding reset signal Vreset of the auxiliary winding resetting detecting circuit 12. The ZVS adjusting circuit 50 delays the auxiliary winding reset signal Vreset for a certain time period. Once the auxiliary winding voltage pulse signal Vbias arrives at the lowest point, the ZVS adjusting circuit 50 generates a clock signal to work as a turn-on control pulse of the switching element 1. Then, the ZVS adjusting circuit 50 provides the clock signal to a set input of the RS latch circuit 9.

The drain current control circuit 8 compares the element current detecting signal Vds of the drain current detecting circuit 2 with the drain current control signal VEAO. Once the element current detecting signal Vds becomes greater than the drain current control signal VEAO, the drain current control circuit 8 provides a reset pulse to the reset input of the RS latch circuit 9.

The RS latch circuit 9 is connected to the control terminal of the switching element 1. The RS latch circuit 9 generates (i) a high-level output signal in response to the clock signal of the ZVS adjusting circuit 50, and (ii) a low-level output signal in response to the reset pulse of the control circuit 8. Then, the RS latch circuit 9 provides the generated output signals to the control terminal as the control signals.

As described above, the switching power supply device according to Embodiment 3 in the present invention employs the quasi-resonant control technique. Specifically, in the switching power supply device, the ZVS adjusting circuit uses (i) the auxiliary winding reset signal Vreset to control the switching element 1 to turn on at the lowest point of the auxiliary winding in order to perform zero-volt switching, and (ii) the drain current control signal VEAO generated out of the auxiliary winding voltage pulse signal Vbias to control a peak of a element current flowing into the switching element 1.

The resulting switching power supply device according to Embodiment 3 is simple in a circuit structure and is capable of achieving highly accurate and stable control on the secondary-side output voltage, so the switching power supply device according to Embodiment 1 is.

Patent Reference 3 (Japanese Unexamined Patent Application Publication No. 62-178172) discloses a switching power supply device having a delaying circuit connected to an auxiliary winding. Such a use of the delaying circuit is common to switching power supply devices performing zero-volt switching. The switching power supply device disclosed in Patent Reference 3 turns on the switching element at the lowest point of an auxiliary winding voltage pulse signal in order to perform zero-volt switching. However, detecting the lowest point of the auxiliary winding voltage pulse signal is difficult. Thus, the switching power device uses the delaying circuit to turn the switching element on when a delayed waveform of the auxiliary winding voltage pulse signal goes low and changes more than a threshold value. The switching power device achieves the zero-voltage switching by setting a delay time period so that timing of which the delayed waveform changes more than the threshold is a point where the auxiliary winding voltage pulse signal drops the lowest.

Concurrently, the switching power supply device according to Embodiment 3 includes a delaying circuit in order to detect an auxiliary winding voltage appearing near an auxiliary winding resetting point. Taking a delay time period, which appears from the auxiliary winding resetting point to provision of the auxiliary winding reset signal Vreset, into consideration, the delaying circuit according to Embodiment 3 has a delay time period set off the delay time period to delay the auxiliary winding voltage. Hence, the delaying circuit can detect a voltage close to the auxiliary winding voltage found at the auxiliary winding resetting point even though the auxiliary winding reset signal Vreset has already provided. Thus, the delaying circuit according to Embodiment 3 in the present invention totally differs from that of Patent Reference 3 in an object of delay and usage of a delayed waveform.

### Embodiment 4

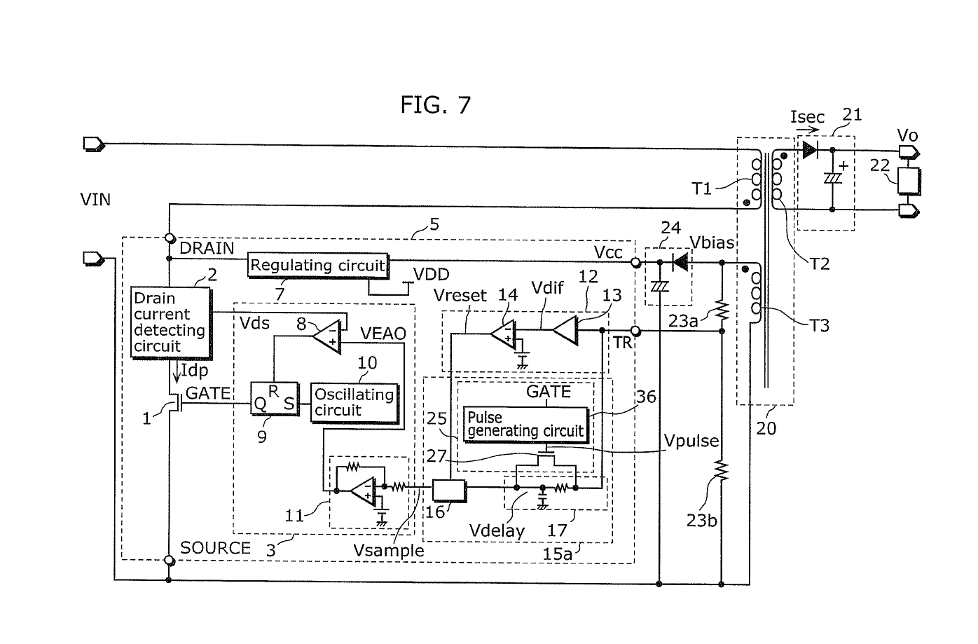

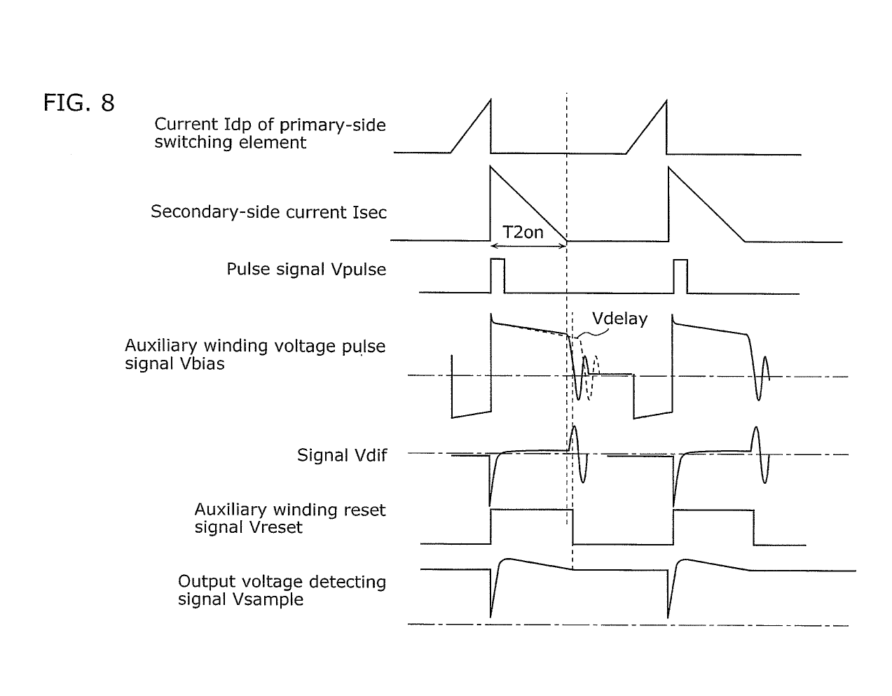

FIG. 7 is a circuit diagram showing a structure of a switching power supply device according to Embodiment 4 in the present invention. FIG. 8 is a timing chart showing an operation of the switching power supply device according to Embodiment 4 in the present invention.

The switching power supply device according to Embodiment 4 includes the following: the control circuit for driving switching element 5, the transformer for power conversion 20, the output voltage generating circuit 21, the resistors 23a and 23b, and the rectification smoothing circuit 24.

The control circuit for driving switching element 5 includes the following: the switching element 1 having a power MOSFET, the drain current detecting circuit 2, the control circuit 3, the regulating circuit 7, the auxiliary winding resetting detecting circuit 12, and an auxiliary winding voltage sample hold circuit 15a. The control circuit for driving switching element 5 includes semiconductor devices (semiconductor devices for a switching power supply) formed on a single semiconductor substrate, and has four terminals as external connecting terminals; namely, the DRAIN terminal, the VCC terminal, the TR terminal, and the SOURCE terminal.

The transformer for power conversion 20 includes the primary winding T1, the secondary winding T2, and the auxiliary winding T3. One terminal on the primary winding T1 included in the transformer for power conversion 20 is connected to a positive terminal provided at an input side (primary side) of the switching power supply device. The other terminal is connected to a negative terminal provided at the input side (primary side) of the switching power supply device via the switching element 1 working as a high voltage semiconductor element.

The switching element 1 has an input terminal, an output terminal, and a control terminal. The input terminal is connected to the primary winding T1. The output terminal is connected to the negative terminal provided at the input side of the switching power supply device. The switching element 1 responds to a control signal applied to the control terminal to switch (oscillate) between electrically connecting (turn-on) and disconnecting (turn-off) the input terminal and the output terminal. Thus, the switching element 1 switches a DC voltage to be supplied to the primary winding T1.

The output voltage generating circuit 21 is connected to the secondary winding T2 included in the transformer for power conversion 20. Through the on-and-off operation (switching operation) of the switching element 1, the output voltage generating circuit 21 generates a DC voltage out of a voltage generated on the secondary-winding T2. Hence, the energy generated on the secondary-winding T2 included in the transformer for power conversion 20 is supplied to the load 22 as a stabilized DC voltage Vo.

The auxiliary winding T3 included in the transformer for power conversion 20 is connected to the rectification smoothing circuit 24 in order to supply a high-voltage input power source to the VCC terminal of the control circuit for driving switching element 5.

In the control circuit for driving switching element 5, (i) the switching element 1 is connected between the DRAIN terminal and the SOURCE terminal, and (ii) the drain current detecting circuit 2 observes an element current flowing into the switching element 1, and provides an element current detecting signal Vds to the control circuit 3. The regulating circuit 7 is connected to the VCC terminal and the DRAIN terminal. The regulating circuit 7 supplies a current from one of the DRAIN terminal and the VCC terminal to a power supply for internal circuit VDD in order to stabilize a voltage of the power supply for internal circuit VDD at a constant value. It is noted that, in FIG. 7, the VCC terminal is connected to the auxiliary winding T3 via the rectification smoothing circuit 24 in order to save power consumption of the control circuit for driving switching element 5. Instead, the VCC terminal may be disconnected from the rectification smoothing circuit 24 and auxiliary winding T3 so that only the power supply for internal circuit VDD can be supplied from the DRAIN terminal.

The auxiliary winding resetting detecting circuit 12 and the auxiliary winding voltage sample hold circuit 15 are connected to the TR terminal.

The auxiliary winding resetting detecting circuit 12 is connected to the auxiliary winding T3 in order to monitor an auxiliary winding voltage pulse signal Vbias generated on the auxiliary winding T3. When the auxiliary winding voltage pulse signal Vbias drops once a secondary-side current Isec flowing into the secondary winding T2 finishes flowing, the auxiliary winding resetting detecting circuit 12 generates an auxiliary winding reset signal Vreset. Here, the signal Vreset indicates timing of which the signal Vbias drops.

The auxiliary winding resetting detecting circuit 12 includes the differentiating circuit 13 and the comparator 14. The differentiating circuit 13 generates a signal Vdif indicating a voltage change in the auxiliary winding voltage pulse signal Vbias. Specifically, the differentiating circuit 13 generates the signal Vdif whose resistor dividing signal of the auxiliary winding voltage pulse signal Vbias provided to the TR terminal is differentially transformed. The comparator 14 compares the signal Vdif with a reference voltage, and generates the auxiliary winding reset signal Vreset.

Hence, the auxiliary winding resetting detecting circuit 12 is capable of detecting a changing point of the auxiliary winding voltage pulse signal Vbias. Here, the changing point of the auxiliary winding voltage pulse signal Vbias is almost equal to timing (hereinafter referred to as an auxiliary winding resetting point) at which the switching element 1 turns off, the secondary-side current Isec flows into the secondary winding T2 of the transformer for power conversion 20, and the secondary-side current Isec disappears.

The auxiliary winding voltage sample hold circuit 15a is connected to the auxiliary winding resetting detecting circuit 12 and the auxiliary winding T3. The auxiliary winding voltage sample hold circuit 15a also includes a delaying circuit 17 to hold (sample) an auxiliary winding voltage pulse signal Vdelay, and a charge accelerating circuit 25. Here, the signal Vdelay is delayed by the delaying circuit 17 at the timing that the auxiliary winding reset signal Vreset indicates.

Specifically, the auxiliary winding voltage sample hold circuit 15a includes the delaying circuit 17, the sample hold circuit 16, and the charge accelerating circuit 25. The delaying circuit 17 is connected to the TR terminal. The sample hold circuit 16 receives the auxiliary winding reset signal Vreset. The charge accelerating circuit 25 minimizes a delay of a rising waveform of the auxiliary winding voltage pulse signal Vbias caused by the delaying circuit 17.

The delaying circuit 17 is structured, for example, in a low-pass filter employing a capacitor and a resistor. The delaying circuit 17 delays the auxiliary winding voltage pulse signal Vbias found on the TR terminal, and provides the delayed auxiliary winding voltage pulse signal Vdelay. The charge accelerating circuit 25 includes a pulse generating circuit 26 and a switch 27. Upon turning off of the switching element 1, or for a certain time period once the auxiliary winding voltage pulse signal Vbias of the TR terminal rises, the charge accelerating circuit 25 short-circuits across the delaying circuit 17 using the switch 27 in order to control to equalize the auxiliary winding voltage pulse signal Vdelay of the delaying circuit 17 with an input signal.

The sample hold circuit 16 holds the signal Vdelay provided from the delaying circuit 17 at least until the switching element 1 turns off in the next period so as to generate an output voltage detecting signal Vsample. Here the signal Vdelay is generated by delaying circuit 17 when the sample hold circuit 16 receives the auxiliary winding reset signal Vreset.

To stabilize the control, a low-pass filter (not shown) may be connected to the output of the sample hold circuit 16.

In FIG. 7, the auxiliary winding resetting detecting circuit 12 includes the differentiating circuit 13; instead, the auxiliary winding resetting detecting circuit 12 may omit the differentiating circuit 13, and include only the comparator 14 as far as the delaying circuit 17 has long enough delay time to be set.

Preferably, the delay time period of the delaying circuit 17 is set longer than a delay time period appearing between the auxiliary winding resetting point and provision of the auxiliary winding reset signal Vreset by the auxiliary winding resetting detecting circuit 12.

The control circuit 3 is connected to the auxiliary winding voltage sample hold circuit 15. Depending on an output of the auxiliary winding voltage pulse signal Vdelay held by the auxiliary winding voltage sample hold circuit 15, the control circuit 3 generates the control signal controlling the switching element 1 to turn on and off, and provides the generated control signal to the control terminal of the switching element 1.

Specifically, the control circuit 3 includes the oscillating circuit 10, the feedback control circuit 11, the drain current control circuit 8, and the RS latch circuit 9.

Connected to the auxiliary winding voltage sample hold circuit 15a, the feedback control circuit 11 compares the output voltage detecting signal Vsample with the reference voltage and amplifies an error so as to generate a drain current control signal VEAO.

The oscillating circuit 10 generates a clock signal working as a turn-on control pulse of the switching element 1, and provides the clock signal to the set input of the RS latch circuit 9.

The drain current control circuit 8 compares the element current detecting signal Vds of the drain current detecting circuit 2 with the drain current control signal VEAO. Once the element current detecting signal Vds becomes greater than the drain current control signal VEAO, the drain current control circuit 8 provides a reset pulse to the reset input of the RS latch circuit 9.

The RS latch circuit 9 is connected to the control terminal of the switching element 1. The RS latch circuit 9 generates (i) a high-level output signal in response to the clock signal of the oscillating circuit 10, and (ii) a low-level output signal in response to the reset pulse of the control circuit 8. Then, the RS latch circuit 9 provides the generated output signals to the control terminal as the control signals.

As described above, the switching power supply device according to Embodiment 4 in the present invention employs the PWM current mode control technique. Specifically, the switching power supply device controls (i) a turn-on of the switching element 1 using a fixed frequency clock signal provided from the oscillating circuit 10, and (ii) a peak of an element current flowing into the switching element 1 using the drain current control signal VEAO generated out of the auxiliary winding voltage pulse signal Vbias.

It is noted that FIG. 7 exemplifies a switching power supply device employing the PWM current mode control technique. Concurrently, the control technique of the control circuit 3 shall not be limited to the PWM current mode control technique as far as the auxiliary winding resetting detecting circuit 12 and the auxiliary winding voltage sample hold circuit 15a generates the output voltage detecting signal Vsample out of the auxiliary winding voltage pulse signal Vbias. For example, Embodiment 4 can be applied to the following: the PWM voltage mode control technique controlling on-duty of the switching element 1 in response to the output voltage detecting signal Vsample; the PFM control technique controlling on-timing, a frequency, and an off time period of the switching element 1 in response to the output voltage detecting signal Vsample; and the quasi-resonant technique.

Since the switching power supply device according to Embodiment 4 causes the charge accelerating circuit 25 to short-circuit the delaying circuit 17 when the auxiliary winding voltage pulse signal Vbias rises, no delay is observed when the auxiliary winding voltage pulse signal Vdelay rises as shown in FIG. 8. Thus, even in the case where the pulse width T2on of the auxiliary winding voltage pulse signal Vbias is narrow, the auxiliary winding voltage pulse signal Vdelay can accurately hold (sample) a value close to auxiliary winding voltage pulse signal Vbias at the auxiliary winding resetting point.

Although only some exemplary Embodiments of this invention have been described in detail above, those skilled in the art will readily appreciate that many modifications are possible in the exemplary Embodiments without materially departing from the novel teachings and advantages of this invention. Accordingly, all such modifications are intended to be included within the scope of this invention.

### INDUSTRIAL APPLICABILITY

The present invention is effective in switching power supply devices, and in particular, in a power supply device which is required of a constant voltage control capability, such as a power supply adapter circuit for an electronics appliance.

What is claimed is:

1. A switching power supply device comprising:
a transformer for power conversion which includes a primary winding, a secondary winding, and an auxiliary winding;
a switching element which (i) includes an input terminal, an output terminal, and a control terminal, and (ii) switches a first direct current (DC) voltage supplied to said primary winding, said input terminal being connected to said primary winding;
an output voltage generating circuit which is connected to said secondary winding and generates a second DC voltage out of a voltage generated on said secondary winding through the switching of said switching element;
an auxiliary winding resetting detecting circuit which (i) is connected to said auxiliary winding, (ii) monitors an auxiliary winding voltage signal generated on said auxiliary winding, and (iii) generates an auxiliary winding reset signal indicating timing of which a secondary-side current finishes flowing into said secondary winding and the auxiliary winding voltage signal drops;
an auxiliary winding voltage sample hold circuit which (i) is connected to said auxiliary winding resetting detecting circuit and to said auxiliary winding, and (ii) holds the auxiliary winding voltage signal; and
a control circuit which (i) is connected to said auxiliary winding voltage sample hold circuit, (ii) generates a control signal controlling said switching element to turn on and off depending on the auxiliary winding voltage signal held by said auxiliary winding voltage sample hold circuit, and (iii) provides the control signal to the control terminal of said switching element,
wherein said auxiliary winding voltage sample hold circuit (I) includes a delaying circuit which delays the auxiliary winding voltage signal, and (ii) holds the auxiliary winding voltage signal delayed by said delaying circuit from reception of the auxiliary winding reset signal by said auxiliary winding voltage sample hold circuit receives to the turn off of said switching element.

2. The switching power supply device according to claim 1,
wherein a delay time period of said delaying circuit is set longer than a time period appearing between (i) timing of which the secondary-side current finishes flowing into said secondary winding and (ii) the generation of the auxiliary winding reset signal by said auxiliary winding resetting detecting circuit.

3. The switching power supply device according to claim 2,
wherein said auxiliary winding resetting detecting circuit includes a differentiating circuit and a comparator, said differentiating circuit generating a signal indicating a change in the auxiliary winding voltage signal, and said comparator comparing the signal with a reference voltage to generate the auxiliary winding reset signal.

4. The switching power supply device according to claim 1,
wherein said auxiliary winding voltage sample hold circuit includes a charge accelerating circuit which minimizes a delay of a rising waveform of the auxiliary winding voltage signal, the delay being caused by said delaying circuit.

5. The switching power supply device according to claim 1,
wherein said auxiliary winding resetting detecting circuit includes a differentiating circuit and a comparator, said differentiating circuit generating a signal indicating a change in the auxiliary winding voltage signal, and said comparator comparing the signal with a reference voltage to generate the auxiliary winding reset signal. 3
